(19) United States
(12) Patent Application Publication
(10) Pub. No.: US 2021/0357518 A1
(43) Pub. Date: Nov. 18, 2021

(54) CONTROL OF ACCESS TO HIERARCHICAL NODES

(71) Applicant: Hewlett- Packard Development Company, L.P., Spring, TX (US)

(72) Inventors: Daryl T. Poe, Fort Collins, CO (US); Emmanuel Dimitri Christian Ledoux, Grenoble (FR); Christoph Graham, Spring, TX (US); Timothy J. Freese, Fort Collins, CO (US)

(73) Assignee: Hewlett- Packard Development Company, L.P., Spring, TX (US)

(21) Appl. No.: 16/972,091

(22) PCT Filed: Feb. 4, 2019
(86) PCT No.: PCT/US2019/016559

§ 371 Date: Dec. 4, 2020

(51) Int. Cl. G06F 21/62; G06F 21/12; G06F 21/64; G06F 21/44; G06F 12/14; G06F 16/22

(52) U.S. Cl. CPC G06F 21/6218; G06F 21/12; G06F 21/64; G06F 21/44; G06F 2221/2137; G06F 16/2255; G06F 2221/2141; G06F 2221/2145; G06F 12/1491

(57) ABSTRACT

An example of a computer-readable medium to store machine-readable instructions. The instructions may be executed by a processor to determine an identity of an application and control access of the application to a hierarchical data structure.

### BACKGROUND

Hierarchical data structures, such as hierarchical trees, may be used to store data. A registry for a computer system may include a hierarchical data structure. Different applications installed on the computer system may store their data in different portions of the hierarchical data structure.

### BRIEF DESCRIPTION OF THE DRAWINGS

Various examples will be described below referring to the following figures:

FIG. 1 shows a computer system with identification instructions and control access instructions in accordance with various examples;

FIG. 2 shows a hierarchical tree with authorization data in accordance with various examples;

FIG. 3 shows a method of determining an identity and controlling access to a hierarchical tree in accordance with various examples;

FIG. 4 shows a method of identifying an application and controlling access to a registry entry in accordance with various examples; and

FIG. 5 shows a method of determining an identity and controlling access to a hierarchical data structure in accordance with various examples.

### DETAILED DESCRIPTION

Hierarchical data structures may be used to represent data in a hierarchy. Hierarchical data structures may be used for registries and databases with commonalities amongst the registry and database entries. The hierarchical data structure may be accessible by multiple applications, with applications storing application data within different branches of the hierarchical data structure. It may be desirable to prevent access to or intentional or unintentional modification of branches by the wrong application.

Authorization data may be stored within the hierarchical data structure itself indicating conditions under which access to a branch of the hierarchical data structure is allowed. The authorization data may include data regarding applications that are authorized to access the branch. The authorization data may include other conditions for accessing the branch. The authorizations may be set at a node or entry of the hierarchical data structure and inherited by child elements. The authorizations for sub-branches may be revoked or modified by descendants.

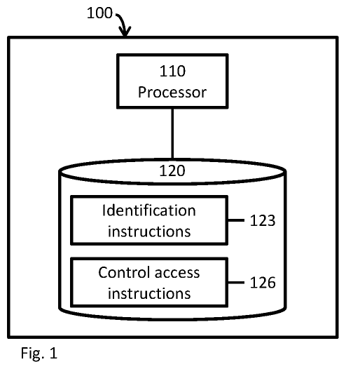

FIG. 1 shows a computer system 100 with identification instructions 123 and control access instructions 126 in accordance with various examples. Computer system 100 includes a processor 110 and storage 120. Storage 120 includes the identification instructions 123 and control access instructions 126. Identification instructions 123 and control access instructions 126 may be executed by processor 110 to perform methods disclosed herein.

The processor 110 may be coupled to the storage 120, such as via a bus. The processor 110 may comprise a microprocessor, a microcomputer, a microcontroller, a field programmable gate array (FPGA), or discrete logic. The processor 110 may execute machine-readable instructions that implement the methods described herein. The storage 120 may include a hard drive, solid state drive (SSD), flash memory, electrically erasable programmable read-only memory (EEPROM), or random access memory (RAM).

The identification instructions 123 may identify an application attempting to access a hierarchical data structure. The hierarchical data structure may be stored in storage 120.

The control access instructions 126 may control access to the hierarchical data structure. The access may be controlled based on the application attempting access, the entry or node being accessed, user information, system information, or other conditions specified by any authorization data for the hierarchical data structure, entry, or node.

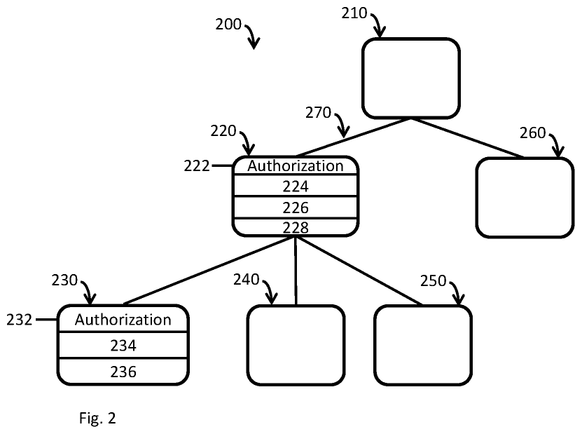

FIG. 2 shows a hierarchical tree 200 with authorization data 222, 232 in accordance with various examples. The hierarchical tree 200 includes nodes 210, 220, 230, 240, 250, 260 coupled together via connections 270. Node 220 includes authorization data 222 and entries 224, 226, 228. Node 230 includes authorization data 232 and entries 234, 236. Authorization data 222, 232 may be considered to be entries of their respective nodes 220, 230. While not depicted, nodes 210, 240, 250, 260 may include entries and authorization data.

Nodes 210, 220, 230, 240, 250, 260 of hierarchical tree 200 may inherit attributes from their ancestors among the nodes 210, 220, 230, 240, 250, 260 of the hierarchical tree 200. For example, node 210 is connected to node 220 via a connection 270. Node 220 may be called a child of node 210. Node 210 may be called a parent of node 220. Nodes 230, 240, 250 may be called children of node 220 and may be called descendants of nodes 210, 220. Node 210 may be called an ascendant of nodes 220, 230, 240, 250, 260. Node 220 may inherit an attribute or data from node 210. Node 230 may inherit an attribute or data from node 220, which may be inherited from node 210. A branch may be considered a node and its descendants, for example, node 220 and the descendant nodes 230, 240, 250 of node 220.

In various examples, a node 210, 220, 230, 240, 250, 260 may have an arbitrary number of children, including no children. For example, node 210 has two children, nodes 220, 260. Node 220 has three children, nodes 230, 240, 250. Nodes 230, 240, 250, 260 have no children. The hierarchical tree 200, number of nodes 210, 220, 230, 240, 250, 260, and number of children depicted are an example. Additional or fewer levels of nodes, number of nodes 210, 220, 230, 240, 250, 260, and number of children for the nodes 210, 220, 230, 240, 250, 260 may be included in the hierarchical tree 200.

The authorization data 222, 232 may indicate applications authorized to modify the data in the hierarchical tree 200. Specifically, authorization data 222 may indicate applications authorized to modify node 220 and the corresponding descendant nodes 230, 240, 250. Authorization data 232 may indicate applications authorized to modify node 230 and any corresponding descendant nodes. The authorization data 222 may include data regarding modification of entries 224, 226, 228, 234, 236, regarding adding or deleting nodes within the branch starting with node 220, or regarding modifying the authorization data 222, 232.

In various examples, a branch may correspond with an application installed on a computer system. For example, the branch starting with node 220 may correspond to a word processing application. The branch starting with node 260 may correspond to a gaming application. The word processing application may access its branch in the hierarchical tree 200 but be prevented from accessing other branches in the hierarchical tree. Other applications may be prevented from accessing the word processing application's branch.

In various examples, the branch starting at node 220 may store data for a word processing application. The authorization data 222 may specify that the word processing application may modify data within that branch, but prevent access of the data by another application. The authorization data 222 may be inherited by the descendent nodes 230, 240, 250 of the branch, so that the word processing application may access any of the nodes 220, 230, 240, 250 such as data in entry 234.

In various examples, different kinds of access may be authorized separately. Access may include read access, write access, delete access, append access, create access, or add access. Other kinds of access are contemplated and may be authorized or restricted. For example, the word processing application corresponding to a branch may have full access, including read access to read the data stored in the branch, write access to modify the data stored in the branch, delete access to delete nodes or entries within the branch, or add access to add nodes or entries to the branch. Other kinds of access may also be controlled. The branch may allow read access to all applications or limit read access to a select set of other applications. Write access may be limited to the word processing application.

In various examples, the authorization data 222 may store conditions to access its node 220 and descendants of that node 220. The authorization data 222 may include an identification of an application. The authorization data 222 may include a hash of the application, which may be used to verify the application has been properly identified or has not been modified, such as by a virus or other malicious program or user. The hash of the application may be verified by identifying a memory location of an executable of the application and hashing the executable into an executable hash for comparison against the hash stored in the authorization data 222. The memory location may be a location in RAM or a file location on a long-term storage device. The authorization data 222 may include a time range when access to the branch is authorized. The authorization data 222 may specify another application be executing at the time of access, such as a security application. The security application may include an anti-virus application or application to detect malware. The authorization data 222 may specify a security device be coupled to the computer system when accessing the branch. The security device may include a physical device to be coupled to the computer to authenticate access authorization. For example, a universal serial bus (USB) device may include a cryptographic function to be solved or a password to be provided to authenticate authorized access.

In various examples, the authorization data may include an identification of users authorized to access the branch. The authorization may be by individual users or by categories of users. A category of users may be users with administrator access or super-administrator access. A category of users, such as super-administrators, may be allowed unrestricted access to the hierarchical tree 200 despite any other restrictions in the authorization data 222.

In various examples, various combinations of conditions may be present in the authorization data. For example, access may be allowed if a particular user is logged in, requesting access via a particular application, and a security application is being executed. Or access may be allowed via any application if an administrator is logged into the computer and the security application is being executed.

In various examples, the authorization data 222 may be inherited by descendants of node 220. Nodes 240, 250 may not include their own authorization data, but access to nodes 240, 250 may still be restricted according to the authorization data 222. Node 230 may include authorization data 232 that is different than the authorization data 222 of its parent node 220. Authorization data 232 may provide additional authorizations or revoke authorizations provided by authorization data 222. Authorization data 232 may completely replace any authorizations provided by authorization data 222. For example, authorization data 222 may specify a set of applications that may access the branch. Authorization data 232 may specify that a particular user be logged in to access the sub-branch starting at node 230, in addition to any limitations imposed by authorization data 222. For example, authorization data 232 may specify a set of applications that may access the branch and a time of day during which the branch may be modified. Authorization data 232 may add applications to the list of authorized applications to access the sub-branch starting at node 230.

In various examples, the branch starting at node 220 may include system data. The system data may include settings such as themes used by an operating system, configuration of display units, and scheduling of execution of security scans. The authorization data 222 may restrict access to applications that are part of a fleet administration system. This may restrict local users from modifying system settings for the computer system. Node 230 may include system data that a local user is allowed to modify. Authorization data 232 may allow a local user to modify entries 234, 236 that may control system settings such as a screensaver graphic and a sleep timer. Authorization data 232 may still restrict access through certain applications.

In various examples, hierarchical data structures other than a hierarchical tree may be used. For example, a hierarchical database could be used with authorizations inherited between database entries.

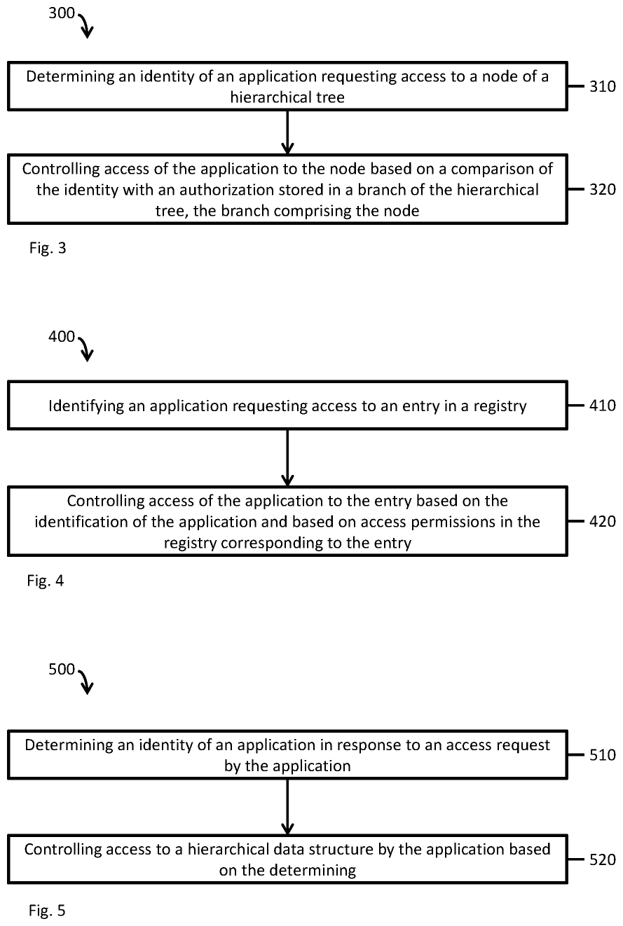

FIG. 3 shows a method 300 of determining an identity and controlling access to a hierarchical tree in accordance with various examples. Method 300 includes determining an identity of an application requesting access to a node of a hierarchical tree (310). Method 300 includes controlling access of the application to the node based on a comparison of the identity with an authorization stored in a branch of the hierarchical tree, the branch comprising the node (320).

Determining an identity of an application may include receiving a process identifier corresponding to the access request. The process identifier may be made available via a socket or an ancillary channel used in interprocess communications of a computer system. The socket or ancillary channel may also make a user identifier available that corresponds to the access request. The process identifier may be used to look up information to uniquely identify the corresponding process. This may include identifying a location of the application, such as a file location or a location in RAM. In various examples, an executable of the application may be checked, such as via a hashing function operating on the executable to produce an executable hash. By executable hash, it is meant that the hash corresponds to the executable, not that the hash value itself includes executable instructions. The executable hash may be compared against a known hash stored in the branch. The hash may be stored as part of authorization data or as an entry in a node.

Access to the node may be controlled based on the identification of the application. If the authorization data stored in the branch allows access by the requesting application, the access request may be processed. If the authorization data does not allow access, the access request may return an error. The authorization to access a particular node may be based on authorization stored in the node and stored in other nodes of the branch. For example, an ancestor node may provide certain access authorizations which are modified by the node to be accessed. Authorizations in a descendant node may broaden, narrow, or replace restrictions from an ancestor node.

In various examples, access may be based on data other than the identity of the application requesting access. These other restrictions may be in addition to or in place of the identity restriction. Such restrictions may include a time indicator, a date indicator, execution of another program, access to a particular network or network resource, a user identifier, a user being logged into a particular network domain, a geolocation, use of a wired network connection instead of a wireless network connection, whether the computer system is booted in a secure configuration or trusted mode, the presence of a hardware component, or execution of an unknown or untrusted application, executable, digitally linked library, process, or sub-process. The restrictions may be positive restrictions or negative restrictions. For example, for access to be authorized, the system may be checked to ensure a particular security application is being executed. For example, for access to be authorized, the system may check to ensure that no unknown or untrusted applications are being executed.

In various examples, geolocation may be used to allow access when that computer system is located within a particular region, such as located on a corporate campus. Geolocation may be used to restrict access if a sudden change in location is detected, such as changing from a location in the United States to a location in China within a few minutes time.

In various examples, telemetry data regarding the computer system may be collected when the access is attempted. The telemetry data may include the location of the computer system, information regarding the network connection, the application requesting access, and the user logged in when access is requested. The telemetry data may be sent to a server for logging. The collection of telemetry data may be limited to when access is to be denied. This may assist systems administrators in identifying security issues within a fleet of corporate computers.

FIG. 4 shows a method 400 of identifying an application and controlling access to a registry entry in accordance with various examples. Method 400 includes identifying an application requesting access to an entry in a registry (410). Method 400 includes controlling access of the application to the entry based on the identification of the application and based on access permissions in the registry corresponding to the entry (420).

In various examples, data may be stored within a registry. The registry may include a hierarchical tree. The hierarchical tree may control access to the registry.

In various examples, read requests and write requests to the entry may have different authorizations. For example, an application may send a read request of a registry entry and receive the requested data. The same application may send a write request to change the same registry entry and receive an error, as the application has authorization to read but not write the registry entry.

FIG. 5 shows a method 500 of determining an identity and controlling access to a hierarchical data structure in accordance with various examples. Method 500 includes determining an identity of an application in response to an access request by the application (510). Method 500 includes controlling access to a hierarchical data structure by the application based on the determining (520). The hierarchical data structure may allow for multiple inheritances and loops within the hierarchical data structure.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

Claims

What is claimed is:

1. A non-transitory computer-readable medium to store machine-readable instructions that, when executed by a processor, cause the processor to:
determine an identity of an application requesting access to a node of a hierarchical tree; and
control access of the application to the node based on a comparison of the identity with an authorization stored in a branch of the hierarchical tree, the branch comprising the node.

2. The computer-readable medium of claim 1, wherein the machine-readable instructions, when executed by the processor, cause the processor to control the access of the application to the node based on a time indicator.

3. The computer-readable medium of claim 1, wherein the machine-readable instructions, when executed by the processor, cause the processor to collect telemetry data in response to the application requesting access to the node.

4. The computer-readable medium of claim 1, wherein to determine the identity of the application comprises to verify a hash of an executable corresponding to the application.

5. The computer-readable medium of claim 1, wherein a second node comprises the authorization, the node is a descendant of the second node, and the node inherits the authorization from the second node.

6. A non-transitory computer-readable medium to store machine-readable instructions that, when executed by a processor, cause the processor to:
identify an application requesting access to an entry in a registry; and
control access of the application to the entry based on the identification of the application and based on access permissions in the registry corresponding to the entry.

7. The computer-readable medium of claim 6, wherein the registry comprises a hierarchical tree.

8. The computer-readable medium of claim 6, wherein to identify the application includes to determine a memory location of an executable of the application.

9. The computer-readable medium of claim 6, wherein to control access of the application to the entry includes to allow the application to read the entry and to return an error to the application in response to a write request.

10. The computer-readable medium of claim 6, wherein the machine-readable instructions, when executed by the processor, cause the processor to control the access of the application to the entry based on an execution of a security application by the processor.

11. A method comprising:
determining an identity of an application in response to an access request by the application; and
controlling access to a hierarchical data structure by the application based on the determining.

12. The method of claim 11, wherein the determining includes:
identifying a file location of an executable of the application based on a process identifier, the process identifier corresponding to the application;
hashing the executable into an executable hash; and
verifying the executable hash against a stored hash corresponding to the executable, the stored hash being stored in the hierarchical data structure.

13. The method of claim 11 comprising:
determining that a security device is coupled to the processor;
verifying the security device based on data from the security device and data from the hierarchical data structure; and
controlling the access to the hierarchical data structure by the application based on the verifying the security device.

14. The method of claim 11 comprising:
determining a user identity based on a user login; and
controlling the access to the hierarchical data structure by the application based on the user identity.

15. The method of claim 11, wherein the controlling access to the hierarchical data structure includes controlling access to a registry, the registry comprising the hierarchical data structure.
